(19) United States
(12) Patent Application Publication
(10) Pub. No.: US 2010/0324183 A1
(43) Pub. Date: Dec. 23, 2010

(54) HALOGEN-FREE FLAME-RETARDANT TPU

(75) Inventors: Oliver Steffen Henze, Damme (DE); Marc Hansen, Mellinghausen (DE); Katja Hackmann, Lohne (DE); Dietmar Meier, Stemwede-Oppendorf (DE); Christian Beckmann, Melle (DE); Oliver Muehren, Osnabrueck (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, LUDWIGSHAFEN (DE)

(21) Appl. No.: 12/918,339

(22) PCT Filed: Feb. 19, 2009
(86) PCT No.: PCT/EP09/51980

§ 371 Date: Aug. 19, 2010

(30) Foreign Application Priority Data
Feb. 21, 2008 (EP) 08151766.6

(51) Int. Cl. C09K 21/14

(52) U.S. Cl. 524/101; 524/133; 524/145; 524/313; 524/386; 524/401; 524/405; 524/409; 524/416; 524/425; 524/430; 524/445; 525/131

(57) ABSTRACT

The present invention relates to a flame-retardant mixture comprising
(A) at least one polyurethane as component A,
(B) at least one flame retardant selected from the group consisting of tallow, ammonium phosphate, ammonium polyphosphate, calcium carbonate, antimony oxide, zinc borate, clay, montmorillonite clay, metal oxides, metal hydroxides, organic phosphinate compounds, organic phosphate compounds, polyhydric alcohols, melamine compounds, chlorinated polyethylene, and mixtures thereof, as component B, and
(C) at least one crosslinking reagent as component C,
   where the at least one crosslinking reagent is at least one isocyanate dissolved in at least one polyurethane, and also to a process for the production of a flame-retardant polyurethane, to the resultant flame-retardant polyurethane, and also to the use of a solution of at least one isocyanate in at least one polyurethane in the production of a flame-retardant polyurethane for increasing the mechanical stability of flame-retardant polyurethanes.

The present invention relates to a flame-retardant mixture comprising at least one polyurethane, at least one flame retardant, and at least one crosslinking reagent, where the at least one crosslinking reagent is at least one isocyanate dissolved in at least one polyurethane, to a process for the production of a flame-retardant polyurethane by mixing of at least one polyurethane, at least one flame retardant, and at least one crosslinking reagent, where the at least one crosslinking reagent is at least one isocyanate dissolved in at least one polyurethane, and to a flame-retardant polyurethane that can be produced by the process mentioned, and to the use of a solution of at least one isocyanate in at least one polyurethane in the production of a flame-retardant polyurethane.

Flame-retardant, thermoplastic polyurethanes and processes for their production are known from the prior art. US 2003/0166749 A1 discloses a flame-retardant, thermoplastic polyurethane which comprises melamine cyanurate as flame retardant and whose mechanical properties are improved by addition of an amount of at most 2% by weight of at least one crosslinking component. Examples of crosslinking components disclosed are trimethylolpropane, pentaerythritol, amines, 3-isocyanato-methyl-3,5,5-trimethylcyclohexyl isocyanate, and the like. US 2003/0166749 A1 moreover discloses a process for the production of a flame-retardant, thermoplastic polyurethane by mixing of the components mentioned using processes known to the person skilled in the art, for example compounding. The document mentioned does not disclose that the crosslinking reagent, for example a diisocyanate, is to be added in the form of concentrated solution in at least one polyurethane.

DE 103 43 121 A1 discloses thermoplastic polyurethanes which comprise metal hydroxides as flame retardants. A feature of these thermoplastic polyurethanes is particularly high molar mass of at least 60 000 g/mol. Said specification does not describe crosslinking of the thermoplastic polyurethanes.

WO 2006/121549 A1 discloses thermoplastic polyurethanes which comprise halogen-free flame retardants. The flame retardants according to WO 2006/121549 A1 comprise an organic phosphinate component, an organic phosphate component, and a polyhydric alcohol. According to the specification mentioned, the flame retardants are mixed by processes known to the person skilled in the art, for example compounding. WO 2006/121549 does not disclose that flame-retardant, thermoplastic polyurethanes can be obtained by adding crosslinking reagents alongside the flame retardants.

EP 0 617 079 A2 discloses self-extinguishing, thermoplastic polyurethanes, and also a process for their production. Flame retardants used comprise one or more organic phosphates and/or one or more organic phosphonates, in particular in a mixture with melamine derivatives. Auxiliaries and/or additives can moreover be added in the mixture according to EP 0 617 079 A2, examples being lubricants, inhibitors, stabilizers with respect to hydrolysis, light, heat, or discoloration, dyes, pigments, and inorganic and/or organic fillers and reinforcing agents. However, EP 0 617 079 A2 does not disclose that crosslinking reagents are to be present alongside the flame retardants in the thermoplastic polyurethane.

WO 2006/134138 A1 discloses a thermoplastic polyurethane which comprises from 20 to 70% by weight of isocyanate dissolved in the thermoplastic polyurethane. WO 2006/134138 A1 does not, however, disclose the use of said thermoplastic polyurethane for the production of a flame-retardant TPU.

The processes according to the prior art give flame-retardant, thermoplastic polyurethanes, but a sufficiently high level of flame retardancy can be achieved only with a high filler level in relation to the flame retardant. Particularly in the case of halogen-free compounds, high filler levels are needed to provide sufficient flame retardancy. Conventional flame retardants are melamine compounds and phosphorus compounds, and also metal hydroxides, and proportions that have to be added of these in order to achieve sufficiently high flame retardancy are from 20 to 60% by weight.

A disadvantage of this type of high proportion of additive is impairment of the mechanical properties of the compounded thermoplastic polyurethane materials, and this inhibits their appropriate use in the market. The first factor responsible for impairment of mechanical properties is the high proportion of filler, but secondly the addition of certain materials during processing also degrades molar mass, and this results in impaired mechanical properties.

It is an object of the present invention to provide a flame-retardant, thermoplastic polyurethane and a process for its production where the mechanical properties of the thermoplastic polyurethane obtained are intended to be the same good mechanical properties that it has in the absence of the flame retardants. A further object is to provide a simple process which can produce the thermoplastic polyurethanes.

A further object was to provide materials with good mechanical properties, good flame retardancy, and a high temperature index to DIN EN ISO 2578.

These objects are achieved via a flame-retardant mixture comprising
(A) at least one polyurethane as component A,
(B) at least one flame retardant selected from the group consisting of tallow, ammonium phosphate, ammonium polyphosphate, calcium carbonate, antimony oxide, zinc borate, clay, montmorillonite clay, metal oxides, metal hydroxides, organic phosphinate compounds, organic phosphate compounds, polyhydric alcohols, melamine compounds, chlorinated polyethylene, and mixtures thereof, as component B, and
(C) at least one crosslinking reagent as component C,
   wherein the at least one crosslinking reagent is at least one isocyanate dissolved in at least one polyurethane.

The objects are further achieved via a process for the production of a flame-retardant polyurethane by mixing of
(A) at least one polyurethane as component A,
(B) at least one flame retardant selected from the group consisting of tallow, ammonium phosphate, ammonium polyphosphate, calcium carbonate, antimony oxide, zinc borate, clay, montmorillonite clay, metal oxides, metal hydroxides, organic phosphinate compounds, organic phosphate compounds, polyhydric alcohols, melamine compounds, chlorinated polyethylene, and mixtures thereof, as component B, and
(C) at least one crosslinking reagent as component C,
   wherein the at least one crosslinking reagent is at least one isocyanate dissolved in at least one polyurethane.

The objects are also achieved by the use of a solution of at least one isocyanate in at least one polyurethane in the production of flame-retardant polyurethanes.

### Component A:

The mixture according to the invention comprises at least one polyurethane as component A.

The polyurethanes that can be used in the mixture according to the invention, preferably thermoplastic polyurethanes, can generally be produced by reaction of
a) organic and/or modified organic diisocyanates with
b) relatively high-molecular-weight, in particular substantially difunctional, polyhydroxy compounds and, if appropriate,
c) chain extenders.

For the purposes of this invention, the abbreviation TPU is also used for the thermoplastic polyurethanes. These are substantially linear, thermoplastically processable polyurethanes known per se. In principle, any of the known TPUs which can be produced by conventional processes is suitable for the mixture of the invention. It is preferable to use polyether TPUs as component A.

The following details relate to the TPUs of the invention and to their structural components a) to c):

Organic and/or modified organic diisocyanates that can be used are aliphatic, cycloaliphatic, or preferably aromatic diisocyanates. Individual examples that may be mentioned are: aliphatic diisocyanates, such as hexamethylene 1,6-diisocyanate, 2-methylpentamethylene 1,5-diisocyanate, 2-ethylbutylene 1,4-diisocyanate, or a mixture composed of at least two of the aliphatic diisocyanates mentioned; cycloaliphatic diisocyanates, such as isophorone diisocyanate, cyclohexane 1,4-diisocyanate, 1-methyl-cyclohexane 2,4- or 2,6-diisocyanate and also the corresponding isomer mixtures, dicyclohexylmethane 4,4′-, 2,4′- and 2,2′-diisocyanate, and also the corresponding isomer mixtures; and preferably aromatic diisocyanates, such as tolylene 2,4-diisocyanate, mixtures composed of tolylene 2,4- and 2,6-diisocyanate, diphenylmethane 4,4′-, 2,4′- and 2,2′-diisocyanate, mixtures composed of diphenylmethane 2,4′- and 4,4′-diisocyanate, urethane-modified liquid diphenylmethane 4,4′- and/or 2,4′-diisocyanates, 4,4′-diisocyanato-1,2-diphenylethane, mixtures composed of 4,4′-, 2,4′-, and 2,2′-diisocyanato-1,2-diphenylethane, and advantageously those whose 4,4′-diisocyanato-1,2-diphenylethane content is at least 95% by weight, and naphthylene-1,5-diisocyanate. It is preferable to use diphenylmethane diisocyanate isomer mixtures whose diphenylmethane 4,4′-diisocyanate content is greater than 96% by weight, and in particular substantially pure diphenylmethane 4,4′-diisocyanate.

There may, if appropriate, be subordinate amounts of a trifunctional polyisocyanate or higher-functionality polyisocyanate replacing the organic diisocyanates, examples being amounts of up to 3 mol %, preferably up to 1 mol %, based on the organic diisocyanate, but this amount must be limited in such a way that the resultant polyurethanes remain thermoplastically processable. Any relatively large amount of these more than difunctional isocyanates is advantageously compensated by concomitant use of less than difunctional compounds having reactive hydrogen atoms, thus avoiding excessive chemical crosslinking of the polyurethane. Examples of more than difunctional isocyanates are mixtures composed of diphenylmethane diisocyanates and polyphenyl polymethylene polyisocyanates, known as crude MDI, and also liquid diphenylmethane 4,4′- and/or 2,4′-diisocyanates modified by isocyanurate groups, by urea groups, by biuret groups, by allophanate groups, by urethane groups, and/or by carbodiimide groups.

Examples that may be mentioned of suitable monofunctional compounds having a reactive hydrogen atom which can also be used as molecular weight regulators are:

monoamines, e.g. butyl-, dibutyl-, octyl-, stearyl-, or N-methylstearylamine, pyrrolidone, piperidine, and cyclohexylamine, and monoalcohols, e.g. butanol, amyl alcohol, 1-ethylhexanol, octanol, dodecanol, cyclohexanol, and ethylene glycol monoethyl ether.

Suitable relatively high-molecular-weight polyhydroxy compounds whose molar masses are from 500 to 8000 g/mol are polyesterdiols and in particular polyetherdiols. An example of a compound used is polybutadienediol, which also gives good results in the production of crosslinkable TPUs. Other polymers containing hydroxy groups and having ether groups or ester groups in the polymer chain can also be used here, examples being polyacetals, such as polyoxymethylenes, and especially formals insoluble in water, e.g. polybutanediol formal and polyhexanediol formal, and polycarbonates, in particular those composed of diphenyl carbonate and 1,6-hexanediol, produced by transesterification. The polyhydroxy compounds should be at least mainly linear and for the purposes of the isocyanate reaction must be substantially of difunctional structure. The polyhydroxy compounds mentioned can be used in the form of individual components or in the form of mixtures.

Suitable polyetherdiols can be produced by known processes, for example by anionic polymerization of alkylene oxides using alkali metal hydroxides, such as sodium hydroxide or potassium hydroxide, or using alkali metal alcoholates, such as sodium methanolate, sodium ethanolate, or potassium ethanolate, or potassium isopropanolate, as catalysts, and with addition of at least one starter molecule which comprises from 2 to 3, preferably 2, reactive hydrogen atoms, or by cationic polymerization using Lewis acids, such as antimony pentachloride, boron fluoride etherate, inter alia, or bleaching earth, as catalysts, from one or more alkylene oxides having from 2 to 4 carbon atoms in the alkylene radical.

Examples of suitable alkylene oxides are tetrahydrofuran, propylene 1,3-oxide, butylene 1,2- or 2,3-oxide, and particularly preferably ethylene oxide and propylene 1,2-oxide. The alkylene oxides can be used individually, in alternating succession, or in the form of a mixture. Examples of starter molecules that can be used are: water, organic dicarboxylic acids, such as succinic acid, adipic acid, and/or glutaric acid, alkanolamines, e.g. ethanolamine, N-alkylalkanolamines, N-alkyldialkanolamines, e.g. N-methyl- and N-ethyldiethanolamine, and preferably dihydric alcohols, if appropriate bonded via ether bridges, e.g. ethanediol, 1,2-propanediol and 1,3-propanediol, 1,4-butanediol, diethylene glycol, 1,5-pentanediol, 1,6-hexanediol, dipropylene glycol, 2-methyl-1,5-pentanediol, and 2-ethyl-1,4-butanediol. The starter molecules can be used individually or in the form of a mixture.

It is preferable to use polyetherols composed of propylene 1,2-oxide and ethylene oxide, where more than 50% of the OH groups in these, preferably from 60 to 80%, are primary hydroxy groups, and where at least a portion of the ethylene oxide has been arranged as terminal block. Polyetherols of this type can be obtained by, for example, first polymerizing the propylene 1,2-oxide onto the starter molecule and then polymerizing the ethylene oxide onto the molecule, or first copolymerizing all of the propylene 1,2-oxide in a mixture with a portion of the ethylene oxide and then polymerizing the remainder of the ethylene oxide onto the molecule, or, in a stepwise method, polymerizing the following onto the starter molecule: first a portion of the ethylene oxide, then all of the propylene 1,2-oxide, and then the remainder of the ethylene oxide.

The tetrahydrofuran polymerization products containing hydroxy groups are moreover particularly suitable.

The usual molar masses of the substantially linear polyetherols are from 500 to 8000 g/mol, preferably from 600 to 6000 g/mol, and in particular from 800 to 3500 g/mol, and the preferred molar masses of the polyoxytetramethylene glycols here are from 500 to 2800 g/mol. They can be used either individually or else in the form of a mixture with one another.

Suitable polyesterdiols can, by way of example, be prepared from dicarboxylic acids having from 2 to 12, preferably from 4 to 6, carbon atoms, and diols. Examples of dicarboxylic acids that can be used are: aliphatic dicarboxylic acids, such as succinic acid, glutaric acid, adipic acid, suberic acid, azelaic acid, and sebacic acid, and aromatic dicarboxylic acids, such as phthalic acid, isophthalic acid, and terephthalic acid.

The dicarboxylic acids can be used individually or in the form of a mixture, e.g. in the form of a mixture of succinic, glutaric, and adipic acid. For preparation of the polyesterols it can be advantageous, if appropriate, to use the corresponding dicarboxylic acid derivatives instead of the dicarboxylic acids, examples being dicarboxylic mono- or diesters having from 1 to 4 carbon atoms in the alcohol radical, dicarboxylic acid anhydrides, or dicarbonyl dichlorides. Examples of the diols are glycols having 2 to 10, preferably from 2 to 6, carbon atoms, e.g. ethylene glycol, diethylene glycol, 1,4-butanediol, 1,5-pentanediol, 1,6-hexanediol, 1,10-decanediol, 2,2-dimethyl-1,3-propanediol, 1,3-propanediol, and dipropylene glycol. As a function of the properties desired, the diols can be used alone or, if appropriate, in a mixture with one another.

Other suitable compounds are the esters of carbonic acid with the diols mentioned, in particular with those having from 4 to 6 carbon atoms, e.g. 1,4-butanediol and/or 1,6-hexanediol; condensates of α-hydroxycarboxylic acids, e.g. α-hydroxycaproic acid, and preferably polymerization products of lactones, an example being, if appropriate substituted, α-caprolactone.

Preferred polyesterdiols used are ethanediol polyadipates, 1,4-butanediol polyadipates, ethanediol 1,4-butanediol polyadipates, 1,6-hexanediol neopentyl glycol polyadipates, 1,6-hexanediol 1,4-butanediol polyadipates, and polycaprolactones.

The molar masses of the polyesterdiols are generally from 500 to 6000 g/mol, preferably from 800 to 3500 g/mol.

Chain extenders that can be used, having molar masses generally from 60 to 400 g/mol, preferably from 60 to 300 g/mol, are aliphatic diols having from 2 to 12 carbon atoms, preferably having 2, 4, or 6 carbon atoms, e.g. ethanediol, 1,6-hexane-diol, diethylene glycol, dipropylene glycol, and in particular 1,4-butanediol. However, other suitable compounds are diesters of terephthalic acid with glycols having from 2 to 4 carbon atoms, e.g. the bis(ethylene glycol) ester of terephthalic acid or the bis(1,4-butanediol) ester of terephthalic acid, and hydroxyalkylene ethers of hydroquinone, e.g. 1,4-di(3-hydroxyethyl)hydroquinone, and also polytetramethylene glycols whose molar masses are from 162 to 378 g/mol.

In order to adjust the hardness and melt index of the TPUs, the amounts used of structural components (b) and (c) can be varied within relatively broad molar ratios, and hardness and melt viscosity here rise with increasing content of chain extender (c), whereas melt index falls.

For production of relatively soft TPUs, e.g. those whose Shore A hardness is smaller than 95, preferably from 95 to 75 Shore A, the molar ratios of the substantially difunctional polyhydroxy compounds (b) and diols (c) used can be, for example, from 1:1 to 1:5, preferably from 1:1.5 to 1:4.5, giving the resultant mixtures composed of (b) and (c) a hydroxy equivalent weight greater than 200, and in particular from 230 to 450, whereas for production of relatively hard TPUs, e.g. those whose Shore A hardness is greater than 98, preferably from 55 to 75 Shore D, the molar ratios of (b) to (c) can be in the range from 1:5.5 to 1:15, preferably from 1:6 to 1:12, giving the resultant mixtures composed of (b) and (c) a hydroxy equivalent weight of from 110 to 200, preferably from 120 to 180.

The amount of component A present in the mixture of the invention is generally from 19 to 89% by weight, preferably from 29 to 79% by weight, particularly preferably from 39 to 69% by weight, based in each case on the entire mixture.

### Component B:

The flame-retardant mixture of the invention moreover comprises at least one flame retardant selected from the group consisting of tallow, ammonium phosphate, ammonium polyphosphate, calcium carbonate, antimony oxide, zinc borate, clay, montmorillonite clay, metal oxides, such as ZnO, B₂O₃, Fe₂O₃, CaO, SiO₂, or a mixture thereof, metal hydroxides, for example Mg(OH)₂, Al(OH)₃, or a mixture thereof, organic phosphinate compounds, organic phosphate compounds, such as triesters of phosphoric acid, e.g. trialkyl phosphates, oligomeric phosphoric esters and, respectively, phosphonic esters, cyclic phosphonates, such as those derived from pentaerythritol or from neopentyl glycol, polyhydric alcohols, melamine compounds, such as melamine, melamine phosphate, melamine cyanurate, melamine borate, and other melamine derivatives, and chlorinated polyethylene, if appropriate with antimony(II) oxide as synergist, and mixtures thereof, as component B.

The phosphoric esters can be used alone or in a mixture with one another, or in a mixture with phosphonic esters. However, it is usual to use phosphoric esters or phosphonic esters. In one particularly suitable flame retardant combination, the phosphoric esters and/or phosphonic esters are used in a mixture together with one or more melamine derivatives for the TPU, the ratio by weight of phosphate and phosphonate to melamine derivative then preferably being in the range from 5:1 to 1:5. The melamine derivatives that can be used here are preferably those mentioned above.

In one particularly preferred embodiment, the flame retardant has been selected from the group consisting of melamine compounds and phosphorus compounds, e.g. melamine cyanurate and, respectively, phosphoric ester, metal hydroxides, particularly preferably Mg(OH)₂, and a mixture thereof.

The proportion of component B generally present in the flame-retardant mixture is from 10 to 80% by weight, preferably from 20 to 70% by weight, particularly preferably from 30 to 60% by weight, based in each case on the entire mixture.

### Component C:

At least one crosslinking agent is present as component C in the flame-retardant mixture of the invention, and is at least one isocyanate dissolved in at least one polyurethane.

In one preferred embodiment, a thermoplastic polyurethane is used as component C in the flame-retardant mixture of the invention and comprises from 20 to 70% by weight, preferably from 25 to 70% by weight, and particularly preferably from 30 to 60% by weight, very particularly preferably from 35 to 60% by weight, of isocyanate dissolved in the thermoplastic polyurethane, based on the total weight of thermoplastic polyurethane (component (C)).

In component C of the invention, there is at least one isocyanate present, dissolved in at least one polyurethane, preferably in at least one thermoplastic polyurethane (TPU), particularly preferably in the soft phase of the thermoplastic polyurethane. Reaction of the isocyanate with the TPU and the resultant degradation or crosslinking of the TPU can in particular be avoided by selecting a sufficiently low temperature during the incorporation process. The change in the molecular weight of the TPU during incorporation of the isocyanates is usually zero or only very small. On the other hand it is preferable that the thermoplastic polyurethane is present in the form of a melt during incorporation of the isocyanate, in order that maximum concentration of isocyanate in the TPU can be achieved with maximum rapidity. It is preferable that the thermoplastic polyurethane of the invention, comprising isocyanate, is stored at a temperature below 40° C. prior to processing.

The NCO content of component C of the mixture of the invention is particularly preferably greater than 5%, preferably greater than 8%, particularly preferably from 10 to 40%.

The NCO content determined here is the entirety composed of isocyanate and allophanate. It is determined by dissolving the specimen in dimethylformamide comprising amine and keeping the mixture at 80° C. for 4 hours. The unreacted excess amine is back-titrated with acid. This method is known to the person skilled in the art and is described by way of example in WO 2006/134138 A1.

Isocyanates that can be present in component C of the invention are well known isocyanates, for example aliphatic, cycloaliphatic, and/or aromatic isocyanates, generally having 2 isocyanate groups. It is also possible to use isocyanates of higher functionality, e.g. polymer MDI or modified isocyanates, e.g. isocyanates which comprise biuret groups and have from 2 to 10 isocyanate groups, isocyanurates which preferably have from 2 to 8, particularly preferably 3, isocyanate groups, and/or prepolymers having from 2 to 10 isocyanate groups, e.g. isocyanates which are obtainable after reaction of isocyanates with compounds reactive toward isocyanates, generally alcohols.

Examples of compounds that can be used are therefore tri-, tetra-, penta-, hexa-, hepta-, and/or octamethylene diisocyanate, 2-methylpentamethylene 1,5-diisocyanate, 2-ethylbutylene 1,4-diisocyanate, pentamethylene 1,5-diisocyanate, butylene 1,4-diiso-cyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclo-hexane 1,4-diisocyanate, 1-methylcyclohexane 2,4- and/or 2,6-diisocyanate, and/or dicyclohexylmethane 4,4′-, 2,4′-, and 2,2′-diisocyanate, diphenylmethane 2,2′-, 2,4′-, and/or 4,4′-diisocyanate (MDI), naphthylene 1,5-diisocyanate (NDI), tolylene 2,4- and/or 2,6-diisocyanate (TDI), 3,3′-dimethyldiphenyl diisocyanate, 1,2-diphenylethane diisocyanate, and/or phenylene diisocyanate.

It is preferable to use MDI, a carbodiimide-modified diphenylmethane 2,2′-, 2,4′-, and/or 4,4′-diisocyanate (MDI), and/or a prepolymer based on diphenylmethane 2,2′-, 2,4′-, and/or 4,4′-diisocyanate (MDI), triisocyanates or polyisocyanates, particularly biurets or isocyanurates of the isocyanates mentioned, particularly an isocyanurate whose NCO content is from 20 to 25% and whose viscosity at 23° C. is from 2500 to 4000 mPas, and/or a mixture of diisocyanates and triisocyanates, preferably a mixture (ii) comprising (iia) compounds having at least three, preferably three, isocyanate groups based on aliphatic isocyanates, preferably hexamethylene diisocyanate (HDI) and/or 1-isocyanato-3,3,5-trimethyl-5-isocyanatomethylcyclohexane (isophorone diisocyanate, IPDI), particularly preferably hexamethylene diisocyanate (HDI), and (iib) compounds having two isocyanate groups based on aromatic isocyanates, preferably diphenylmethane 2,2′-, 2,4′-, and/or 4,4′-diisocyanate (MDI), particularly preferably diphenylmethane 4,4′-diisocyanate. As (iia) it is particularly preferable to use an isocyanurate having three isocyanate groups, preferably an isocyanurate based on HDI, i.e. a trimerized HDI, in which three HDIs form an isocyanurate structure and three free isocyanate groups are present. As (iia) it is particularly preferable to use an isocyanurate whose NCO content is from 20 to 25%, preferably from 21.5 to 22.5%, and whose viscosity at 23° C. is from 2500 to 4000 mPas. As (iib) it is preferable to use diphenylmethane 2,2′-, 2,4′-, and/or 4,4′-diisocyanate (MDI), a carbodiimide-modified MDI, and/or a prepolymer based on MDI. As (iib) it is particularly preferable to use a prepolymer based on diphenylmethane 2,2′-, 2,4′-, and/or 4,4′-diisocyanate (MDI), alkanediol, preferably dipropylene glycol, with a molar mass of from 60 to 400 g/mol, and polyetherdiol, preferably polypropylene glycol ether, with a molar mass of from 500 to 4000 g/mol. As (iib), it is particularly preferable to use a prepolymer whose viscosity at 25° C. is from 500 to 800 mPas, preferably from 550 to 770 mPas, and whose NCO content is from 20 to 25%, preferably from 22.4 to 23.4%. It is particularly preferable to use (iia) and (iib) in a ratio by weight of (Ha) to (iib) of 1:1 and 1:10, preferably of 1:3 and 1:4.

Particularly preferred as isocyanate are diphenylmethane 2,2′-, 2,4′-, and/or 4,4′-diisocyanate (MDI), a carbodiimide-modified diphenylmethane 2,2′-, 2,4′-, and/or 4,4′-diisocyanate (MDI), a prepolymer based on diphenylmethane 2,2′-, 2,4′-, and/or 4,4′-diisocyanate (MDI), preferably a prepolymer whose NCO content is from 20 to 25% and whose viscosity at 25° C. is from 500 to 1000 mPas determined to DIN 53018, isocyanates having biuret and/or isocyanurate groups, particularly preferably isocyanurate whose NCO content is from 20 to 25% and whose viscosity at 23° C. is from 2500 to 4000 mPas, determined to DIN EN ISO 3219, in particular based on hexamethylene diisocyanate (HDI).

Particular preference is given to carbodiimide-modified diphenylmethane 4,4′-diisocyanate (MDI), particularly preferably with isocyanate content of from 25 to 33% by weight, in particular 29.5% by weight, for example Lupranat® MM 103 (BASF SE), prepolymer based on ethylene oxide/propylene oxide, preferably with a molar mass of from 400 to 600 g/mol, Mw particularly being 450 g/mol, preferably with isocyanate content of from 20 to 28% by weight, in particular 23% by weight, for example Lupranat® MP 102 (BASF SE), and/or a trimerized hexamethylene diisocyanate preferably with isocyanate content of from 20 to 28% by weight, in particular 23% by weight, for example Basonat® HI 100 (BASF SE).

The thermoplastic polyurethane used as component C, comprising the isocyanates, can be produced using well known thermoplastic polyurethanes, e.g. those based on aliphatic or aromatic starting substances.

The thermoplastic polyurethanes into which the isocyanates are introduced and which then represent component C, thermoplastic polyurethanes comprising the isocyanates, can be of well known hardness. However, thermoplastic polyurethanes whose Shore hardness is 80 A is 60 D, particularly preferably is 85 A to 95 A, in particular from 90 A to 95 A are particularly preferred as starting material for production of component C. Thermoplastic polyurethanes in these preferred hardness ranges are preferred for two reasons for the production of the inventive thermoplastic polyurethanes comprising the isocyanates: firstly, the isocyanate is mainly dissolved in the soft phase, and the TPU should therefore have maximum softness, to permit dissolution of a large amount of isocyanate in the TPU, and secondly the particles of the TPU should be adequately flowable after the incorporation process. This is achieved in that the TPU has sufficient hardness to permit sufficiently rapid crystallization of the hard phase after the incorporation of the isocyanate.

The thermoplastic polyurethane used as component C and comprising the isocyanates can preferably take the form of a granulated material, preferably with a preferred average particle diameter of from 0.05 mm to 10 mm, preferably from 1 mm to 5 mm. Any of the processes known to the person skilled in the art can be used for the production of the thermoplastic polyurethane present as component C in the mixture of the invention, an example being to melt thermoplastic polyurethane and then to incorporate the isocyanate preferably homogeneously into the thermoplastic polyurethane melt. The intended temperature of the resultant thermoplastic polyurethane melt here is preferably from 120° C. to 160° C. It is particularly preferable to melt the thermoplastic polyurethane at a temperature of from 170° C. to 280° C., preferably from 170 to 240° C., and then to admix the isocyanate at temperatures of from 20 to 80° C. into this melt, so that the temperature of the resultant mixture is below 160° C., preferably from 120 to 160° C. An advantage of this type of processing with a target temperature below 160° C. is that, at said temperature, degradation of the thermoplastic polyurethane can be avoided via addition of diisocyanates, or crosslinking of the thermoplastic polyurethane can be avoided via introduction of tri- or polyisocyanates.

The isocyanate can preferably be incorporated into the thermoplastic polyurethane by means of an extruder, preferably by means of a twin-screw extruder. The product obtainable from the extruder, i.e. the thermoplastic polyurethane comprising isocyanate, corresponding to component C, can preferably be cooled in a water bath directly after discharge from the die of the extruder, and the resultant strand can then, by way of example, be pelletized by well known processes.

In another possible preferred method, the product obtainable from the extruder, i.e. the TPU melt comprising the isocyanate, is extruded directly from the extruder into a water bath through a multistrand die and then divided by a rotating knife (underwater pelletization). The TPU melt here is preferably extruded into water, preferably through a multistrand die, and divided by a rotating knife, preferably in the water.

The amount generally present of component C in the mixture of the invention is from 0.1 to 30% by weight, preferably from 1 to 20% by weight, particularly from 1 to 8% by weight, based in each case on the entire mixture.

If appropriate, the mixture of the invention can comprise further additives alongside components A, B, and C. Suitable additives are known to the person skilled in the art, examples being those selected from the auxiliaries and/or additional substances known to the person skilled in the art, e.g. lubricants, inhibitors, stabilizers with respect to hydrolysis, light, heat, or discoloration, dyes, pigments, inorganic and/or organic fillers and reinforcing agents, and mixtures thereof. It is also possible to add other homo- or copolymers which are not polyurethanes. Examples of these are polyoxymethylenes, polyolefins, polyesters, polycarbonates, polyesterol, acrylonitrile-butadiene-styrene copolymer (ABS), acrylate-styrene-acrylonitrile copolymer (ASA), styrene-acrylonitrile copolymer (SAN), polyamides, or poly(meth)acrylates, or a mixture of these.

In one preferred embodiment, the amounts of the mixture of the invention are as follows: from 29 to 79% by weight of component A, from 20 to 70% by weight of component B, and from 1 to 20% by weight of component C, the total of the amounts of components A, B, and C giving 100% by weight.

In one particularly preferred embodiment, the amounts in the mixture of the invention are as follows: from 39 to 69% by weight of component A, from 30 to 60% by weight of component B, and from 1 to 8% by weight of component C, the total of the amounts of components A, B, and C giving 100% by weight.

If further additives are present in the mixture, the entirety of all of the components gives 100% by weight.

The present invention also provides a process for the production of a flame-retardant polyurethane by mixing of
(A) at least one polyurethane as component A,
(B) at least one flame retardant selected from the group consisting of tallow, ammonium phosphate, ammonium polyphosphate, calcium carbonate, antimony oxide, zinc borate, clay, montmorillonite clay, metal oxides, metal hydroxides, organic phosphinate compounds, organic phosphate compounds, polyhydric alcohols, melamine compounds, chlorinated polyethylene, and mixtures thereof, as component B, and
(C) at least one crosslinking reagent as component C,
   wherein the at least one crosslinking reagent is at least one isocyanate dissolved in at least one polyurethane,

If appropriate, it is also possible to add at least one further additive. The statements made above in relation to the flame-retardant mixture apply to components A, B, and C and to the at least one additive optionally present.

In one preferred embodiment, components A, B, C, and, if appropriate, at least one additive are mixed simultaneously. However, any other sequence is also possible.

Processes for the mixing of the components mentioned are known to the person skilled in the art, examples being coextrusion, and compounding, described by way of example in DE 10343121 A1.

An example of a method for production of the thermoplastic polyurethane of the invention, comprising components A, B, and C melts thermoplastic polyurethane (component A) at a temperature of from 170° C. to 280° C., preferably from 170 to 240° C., and then incorporates components B and C preferably homogeneously into the thermoplastic polyurethane melt.

Components B and C can preferably be incorporated into the thermoplastic polyurethane (component A) by means of an extruder, preferably by means of a twin-screw extruder.

The product obtainable from the extruder, i.e. the thermoplastic polyurethane comprising isocyanate, comprising components A, B and C, can preferably be cooled in a water bath directly after discharge from the die of the extruder, and the resultant strand can then, by way of example, be pelletized by well known processes.

In another possible preferred method, the product obtainable from the extruder, i.e. the TPU melt comprising components A, B and C, is extruded directly from the extruder into a water bath through a multistrand die and then divided by a rotating knife (underwater pelletization). The TPU melt here is preferably extruded into water, preferably through a multistrand die, and divided by a rotating knife, preferably in the water.

The flame-retardant polyurethane produced by the process of the invention features particularly good mechanical properties, for example high tensile strength and tensile strain at brake. Tensile strength can thus be increased, for example by from 10 to 100%, in comparison with conventional flame-retardant polyurethanes, composed of components A and B.

The flame-retardant polyurethane produced by the process of the invention moreover has a particularly high molar mass, for example a weight-average molar mass greater than 40 000 g/mol, preferably greater than 60 000 g/mol.

The flame-retardant polyurethane produced by the invention moreover exhibits a particularly high level of flame retardancy, e.g. in the V-2, V-1 or V-0 classification UL 94 V vertical test of Underwriters Laboratories.

A feature of the flame-retardant polyurethane produced by the invention is therefore that it has not only a high level of flame retardancy but also very good mechanical properties.

The present invention therefore also provides a flame-retardant polyurethane that can be produced by the process of the invention.

The flame-retardant polyurethane of the invention obtains its particular properties through the use of a solution of at least one isocyanate in at least one polyurethane (component C) during the production of a flame-retardant polyurethane.

The present invention therefore also provides the use of a solution of at least one isocyanate in at least one polyurethane in the production of a flame-retardant polyurethane.

The present invention also provides the use of a solution of at least one isocyanate in at least one polyurethane for increasing the mechanical stability of flame-retardant polyurethanes. Examples of properties used here for mechanical stability are tensile strength, tensile strain at break, and abrasion.

The present invention also provides the use of a mixture of the invention for the production of moldings, such as rollers, shoe soles, cladding in automobiles, hoses, coatings, cables, profiles, laminates, floors for buildings and conveyances, plug connectors, cable plugs, bellows, drag cables, solar modules, wiper blades, cable sheathing, gaskets, drive belts, or damping elements, or foils or fibers, by injection molding, calendering, powder sintering, or extrusion. Processes for the production of moldings by injection molding or extrusion are well known to the person skilled in the art. The processing temperature during the production of foils, moldings, or fibers here is preferably from 150 to 230° C., particularly preferably from 180 to 220° C. It is preferable that the mixture of the invention is processed to give the desired foils, moldings, and/or fibers directly after or during the mixing of the components, since thermoplastic processing of the polyisocyanate polyaddition products to give foils, moldings, or fibers is preferably carried out prior to and/or during the crosslinking process.

The present invention also provides moldings, for example rollers, shoe soles, cladding in automobiles, hoses, cable plugs, bellows, drag cables, wiper blades, cable sheathing, gaskets, drive belts, or damping elements, or foils or fibers, comprising a mixture of the invention.

The present invention also provides moldings, such as the above-mentioned, comprising a flame-retardant polyurethane that can be produced by the invention.

The statements made above are applicable in relation to the solution of at least one isocyanate in at least one polyurethane, the polyurethanes, flame retardants, the further optional additives, the amounts, and further details.

### EXAMPLES

Concentrate I and concentrate II are crosslinking reagents (component C) which are produced via dissolution of respectively an isocyanate-containing prepolymer in a polyurethane. The table below gives the precise constitutions.

| | Concentrate I | Concentrate II |
|---|---|---|
| Parent TPU | Elastollan ® C 85 A | Elastollan ® C 85 A |
| Isocyanate-containing | Prepolymer A | Prepolymer B |
| prepolymer | | |
| Found NCO (%) | 8 | 10 |

Prepolymer A is a prepolymer composed of MDI as diisocyanate component, dipropylene glycol, and ethylene oxide-propylene oxide polyetherdiol whose molar mass is 450 g/mol, as dihydroxy components. The NCO content of this prepolymer is 23% by weight.

Prepolymer B is a polymer composed of 2.0% of 2,4″-MDI, 61% of 4,4′-MDI, 12% of 3-ring MDI, 3% of 4-ring MDI, and 14% of relatively highly condensed MDI, as dihydroxy components, and also of an ethylene oxide-propylene oxide polyetherdiol whose molar mass is 450 g/mol as dihydroxy component.

The processes described in WO 2006/134138 were used to produce concentrate I and II.

Elastollan® 1185 A is a polyurethane composed of polytetrahydrofuran and butanediol as diol components and MDI as isocyanate component, its hardness being 85 Shore A. Melapur® is a melamine cyanurate. Fyrolflex RDP™ is a phosphoric ester (resorcinol bis(diphenyl phosphate)) and Magnifin® is a magnesium hydroxide (Mg(OH)₂).

Methods known to the person skilled in the art were used for determination of mechanical properties:
determination of density of TPU by the flotation method to DIN EN ISO 1183-1, A,
Shore A hardness tested to DIN 53505,
tensile test on TPU (tensile strength and tensile strain at break) to DIN 53504,
tear strength test on TPU (with incision) to DIN ISO 34-1, B (b),
determination of abrasion to DIN ISO 4649.

The weight-average molecular weights are determined by the methods described in DE 10343121, paragraphs 0010 and 0011.

The amounts of the individual components are stated in parts by weight below. The person skilled in the art knows how to convert parts by weight to percent by weight.

### Example 1

### Comparative Example

Elastollan® 1185A from Elastogran GmbH (67.5 parts by weight, component A), MELAPUR® MC15 from Ciba® (25 parts by weight, component B), and Fyrolflex® RDP (7.5 parts by weight; component B) from Supresta are mixed using a twin-screw extruder. The resultant mixture is then extruded to give strips (thickness 2 mm).

### Example 2

Elastollan® 1185A from Elastogran GmbH (67.5 parts by weight, component A), MELAPUR® MC15 from Ciba® (25 parts by weight, component B), and Fyrolflex® RDP (7.5 parts by weight; component B) from Supresta are mixed using a twin-screw extruder. The resultant mixture is then extruded to give strips (thickness 2 mm) with addition of concentrate I from Elastogran (2 parts by weight, component C).

### Example 3

The table below shows the constitution of the strips, selected mechanical properties, and also an assessment of flame retardancy to UL 94V. The change in mechanical properties through addition of component C relates to tensile strength, tensile strain at break, and the stress values at various tensile strain values. Higher weight-average molecular weights are obtained through addition of the crosslinking component C.

| | | Example 1 | |
|---|---|---|---|
| | | (comparative | |
| | | example) | Example 2 |
| Elastollan ® 1185A | parts by weight | 67.5 | 67.5 |
| (component A) | | | |
| Melapur ® MC15 | parts by weight | 25 | 25 |
| (component B) | | | |
| Fyrolflex ™ RDP | parts by weight | 7.5 | 7.5 |
| (component B) | | | |
| Concentrate I | parts by weight | 0 | 2 |
| (component C) | | | |
| Tensile strength | [MPa] | 35 | 40 |
| Tensile strain at break | [%] | 590 | 530 |
| 100% stress value | [MPa] | 7.6 | 8.4 |
| 300% stress value | [MPa] | 9.6 | 11.4 |
| UL 94 V (3 mm) | | V-0 | V-0 |
| Weight-average molar | [g/mol] | 114 000 | 149 000 |
| mass | | | |

### Example 4

### Comparative Example

Elastollan® 1185A from Elastogran GmbH (60 parts by weight, component A), MELAPUR® MC15 from Ciba® (40 parts by weight, component B), are mixed using a twin-screw extruder. The resultant mixture is then extruded to give strips (thickness 2 mm).

### Example 5

Elastollan® 1185A from Elastogran GmbH (60 parts by weight, component A), MELAPUR® MC15 from Ciba® (40 parts by weight, component B), are mixed using a twin-screw extruder. The resultant mixture is then extruded to give strips (thickness 2 mm), with addition of concentrate I from Elastogran (2 parts by weight, component C).

### Example 6

Elastollan® 1185A from Elastogran GmbH (60 parts by weight, component A), MELAPUR® MC15 from Ciba® (40 parts by weight, component B), are mixed using a twin-screw extruder. The resultant mixture is then extruded to give strips (thickness 2 mm), with addition of concentrate I from Elastogran (6 parts by weight, component C).

### Example 7

The table below shows the constitution of the strips and selected mechanical properties. The change in mechanical properties through addition of component C relates to tensile strength, tensile strain at break, tear strength, and the stress values at various tensile strain values. Higher weight-average molecular weights are obtained through addition of the crosslinking component C.

| | | Example 4 | | |
|---|---|---|---|---|
| | | (comparative | | |
| | | example) | Example 5 | Example 6 |
| Elastollan ® | parts by | 60 | 60 | 60 |
| 1185A | weight | | | |
| (component A) | | | | |
| Melapur ® | parts by | 40 | 40 | 40 |
| MC15 | weight | | | |
| (component B) | | | | |
| Concentrate I | parts by | 0 | 2 | 6 |
| (component C) | weight | | | |
| Tensile strength | [MPa] | 15 | 19 | 25 |
| Tensile strain at | [%] | 470 | 410 | 380 |
| break | | | | |
| Tear strength | N/mm | 80 | 66 | 55 |
| 100% stress value | [MPa] | 10.5 | 11.5 | 14.2 |
| 300% stress value | [MPa] | 11.9 | 14.6 | 18.3 |
| UL 94 V (3 mm) | | V-1 | V-1 | V-1 |
| Weight-average | [g/mol] | 84 000 | not | 257 000 |
| molar mass | | | determined | |

### Example 8

### Comparative Example

Elastollan® 1185A from Elastogran GmbH (60 parts by weight, component A), Magnifin® H5 MV from Albemarle Corporation (40 parts by weight, component B), are mixed using a twin-screw extruder. The resultant mixture is then extruded to give strips (thickness 2 mm).

### Example 9

Elastollan® 1185A from Elastogran GmbH (60 parts by weight, component A), Magnifin® H5 MV from Albemarle Corporation (40 parts by weight, component B), are mixed using a twin-screw extruder. The resultant mixture is then extruded to give strips (thickness 2 mm), with addition of concentrate I from Elastogran (2 parts by weight, component C).

### Example 10

The table below shows the constitution of the strips and selected mechanical properties. The change in mechanical properties through addition of component C relates to tensile strength, tensile strain at break, tear strength, and the stress values at various tensile strain values. Higher weight-average molecular weights are obtained through addition of the crosslinking component C.

| | | Example 8 | |
|---|---|---|---|
| | | (comparative | |
| | | example) | Example 9 |
| Elastollan ® 1185A | parts by | 60 | 60 |
| (component A) | weight | | |
| Magnifin ® H5 MV | parts by | 40 | 40 |
| (component B) | weight | | |
| Concentrate I | parts by | 0 | 2 |
| (component C) | weight | | |
| Tensile strength | [MPa] | 22 | 25 |
| Tensile strain at break | [%] | 620 | 500 |
| Tear strength | N/mm | 65 | 60 |
| 100% stress value | [MPa] | 6.6 | 7.3 |
| 300% stress value | [MPa] | 7.2 | 8.6 |
| Weight-average molar mass | [g/mol] | 71 000 | 96 000 |

### Example 11

### Comparative Example

Elastollan® 1185A from Elastogran GmbH (50 parts by weight, component A), Magnifin® H5 MV from Albemarle Corporation (50 parts by weight, component B), are mixed using a twin-screw extruder. The resultant mixture is then extruded to give strips (thickness 2 mm).

### Example 12

Elastollan® 1185A from Elastogran GmbH (50 parts by weight, component A), Magnifin® H5 MV from Albemarle Corporation (50 parts by weight, component B), are mixed using a twin-screw extruder. The resultant mixture is then extruded to give strips (thickness 2 mm), with addition of concentrate I from Elastogran (2 parts by weight, component C).

### Example 13

The table below shows the constitution of the strips and selected mechanical properties. The change in mechanical properties through addition of component C relates to tensile strength, tensile strain at break, tear strength and the stress values at various tensile strain values. Higher weight-average molecular weights are obtained through addition of the crosslinking component C.

| | | Example 11 | |
|---|---|---|---|
| | | (comparative | |
| | | example) | Example 12 |
| Elastollan ® 1185A | parts by weight | 50 | 50 |
| (component A) | | | |
| Magnifin ® H5 MV | parts by weight | 50 | 50 |
| (component B) | | | |
| Concentrate I | parts by weight | 0 | 2 |
| (component C) | | | |
| Tensile strength | [MPa] | 10 | 17 |
| Tensile strain at break | [%] | 490 | 460 |
| Tear strength | N/mm | 54 | 58 |
| 100% stress value | [MPa] | 5.9 | 7.0 |
| 300% stress value | [MPa] | 6.0 | 7.9 |
| Weight-average molar mass | [g/mol] | 65 000 | 92 000 |

### Example 14

### Comparative Example

Elastollan® 1185A from Elastogran GmbH (40 parts by weight, component A), Magnifin® H5 MV from Albemarle Corporation (60 parts by weight, component B), are mixed using a twin-screw extruder. The resultant mixture is then extruded to give strips (thickness 2 mm).

### Example 15

Elastollan® 1185A from Elastogran GmbH (40 parts by weight, component A), Magnifin® H5 MV from Albemarle Corporation (60 parts by weight, component B), are mixed using a twin-screw extruder. The resultant mixture is then extruded to give strips (thickness 2 mm), with addition of concentrate I from Elastogran (2 parts by weight, component C).

### Example 16

The table below shows the constitution of the strips and selected mechanical properties. The change in mechanical properties through addition of component C relates to tensile strength, tensile strain at break, tear strength, and the stress value at 50% tensile strain. Higher weight-average molecular weights are obtained through addition of the crosslinking component C.

| | | Example 14 | |
|---|---|---|---|
| | | (comparative | |
| | | example) | Example 16 |
| Elastollan ® 1185A | parts by weight | 40 | 40 |
| (component A) | | | |
| Magnifin ® H5 MV | parts by weight | 60 | 60 |
| (component B) | | | |
| Concentrate I | parts by weight | 0 | 2 |
| (component C) | | | |
| Tensile strength | [MPa] | 6 | 7 |
| Tensile strain at break | [%] | 80 | 360 |
| Tear strength | N/mm | 42 | 47 |
| Stress valve 50% | [MPa] | 5.33 | 6.13 |
| Weight-average molar mass | [g/mol] | 52 000 | 79 000 |

### Example 17

### Comparative Example

Elastollan® 1185A from Elastogran GmbH (67.5 parts by weight, component A), MELAPUR® MC15 from Ciba® (25 parts by weight, component B), and Fyrolflex® RDP (7.5 parts by weight; component B) from Supresta are mixed using a twin-screw extruder. The resultant mixture is then processed to give injection-molded sheets (thickness 2 mm).

### Example 18

Elastollan® 1185A from Elastogran GmbH (67.5 parts by weight, component A), MELAPUR® MC15 from Ciba® (25 parts by weight, component B), and Fyrolflex® RDP (7.5 parts by weight; component B) from Supresta are mixed using a twin-screw extruder. The resultant mixture is then processed to give injection-molded sheets (thickness 2 mm) with addition of concentrate I from Elastogran (2 parts by weight, component C).

### Example 19

Elastollan® 1185A from Elastogran GmbH (67.5 parts by weight, component A), MELAPUR® MC15 from Ciba® (25 parts by weight, component B), and Fyrolflex® RDP (7.5 parts by weight; component B) from Supresta are mixed using a twin-screw extruder. The resultant mixture is then processed to give injection-molded sheets (thickness 2 mm) with addition of concentrate I from Elastogran (6 parts by weight, component C).

### Example 20

The table below shows the constitution of the injection-molded sheets and selected mechanical properties. The change in mechanical properties through addition of component C relates to tensile strength, tensile strain at break, abrasion, and the stress values at various tensile strain values. Insoluble products are obtained through addition of the crosslinking component C.

| | | Ex. 17 | | |
|---|---|---|---|---|
| | | (comparative ex.) | Ex. 18 | Ex. 19 |
| Elastollan ® 1185A | parts by weight | 67.5 | 67.5 | 67.5 |
| (component A) | | | | |
| Melapur ® MC15 | parts by weight | 25 | 25 | 25 |
| (component B) | | | | |
| Fyrolflex ™ RDP | parts by weight | 7.5 | 7.5 | 7.5 |
| (component B) | | | | |
| Concentrate I | parts by weight | 0 | 2 | 6 |
| (component C) | | | | |
| Density | [g/cm3] | 1.233 | 1.233 | 1.232 |
| Shore A | [A] | 91 | 91 | 91 |
| Tensile strength | [MPa] | 22 | 26 | 30 |
| Tensile strain at break | [%] | 320 | 460 | 390 |
| Abrasion | [mm3] | 41 | 32 | 33 |
| 100% stress value | [MPa] | 10.0 | 10.1 | 11.4 |
| 300% stress value | [MPa] | 12.9 | 13.7 | 17.3 |
| Weight-average | [g/mol] | 113 000 | not determined | insoluble |
| molecular weight | | | | |

### Example 21

### Comparative Example

Elastollan® 1185A from Elastogran GmbH (60 parts by weight, component A) and MELAPUR® MC15 from Ciba® (40 parts by weight, component B) are mixed using a twin-screw extruder and then processed to give injection-molded sheets (thickness 2 mm).

### Example 22

Elastollan® 1185A from Elastogran GmbH (60 parts by weight, component A) and MELAPUR® MC15 from Ciba® (40 parts by weight, component B) are mixed using a twin-screw extruder. The resultant mixture is then processed to give injection-molded sheets (thickness 2 mm), with addition of concentrate I from Elastogran (2 parts by weight, component C).

### Example 23

Elastollan® 1185A from Elastogran GmbH (60 parts by weight, component A) and MELAPUR® MC15 from Ciba® (40 parts by weight, component B) are mixed using a twin-screw extruder. The resultant mixture is then processed to give injection-molded sheets (thickness 2 mm), with addition of concentrate I from Elastogran (6 parts by weight, component C).

### Example 24

The table below gives the constitution of the injection-molded sheets and selected mechanical properties. The change in mechanical properties through addition of component C relates to tensile strength, tensile strain at break, abrasion, tear strength, and the stress values at various tensile strain values. Insoluble products are obtained through addition of the crosslinking component C.

| | | Ex. 21 | | |
|---|---|---|---|---|
| | | (comparative | | |
| | | ex.) | Ex. 22 | Ex. 23 |
| Elastollan ® 1185A | parts by | 60 | 60 | 60 |
| (component A) | weight | | | |
| Melapur ® MC15 | parts by | 40 | 40 | 40 |
| (component B) | weight | | | |
| Concentrate I | parts by | 0 | 2 | 6 |
| (component C) | weight | | | |
| Shore A | [A] | 94 | 94 | 94 |
| Tensile strength | [MPa] | 14 | 18 | 23 |
| Tensile strain at break | [%] | 490 | 480 | 360 |
| Tear strength | [N/mm] | 74 | 76 | 62 |
| Abrasion | [mm3] | 55 | 37 | 38 |
| 100% stress value | [MPa] | 9.8 | 10.7 | 13.1 |
| 300% stress value | [MPa] | 10.7 | 12.4 | 17.7 |
| Weight-average molar | [g/mol] | 82 000 | not | insoluble |
| mass | | | determined | |

### Example 25

### Comparative Example

Elastollan® 1185A from Elastogran GmbH (60 parts by weight, component A) and Magnifin® H5 MV from Albemarle Corporation (40 parts by weight, component B) are mixed using a twin-screw extruder. The resultant mixture is then processed to give injection-molded sheets (thickness 2 mm).

### Example 26

Elastollan® 1185A from Elastogran GmbH (60 parts by weight, component A) and Magnifin® H5 MV from Albemarle Corporation (40 parts by weight, component B) are mixed using a twin-screw extruder. The resultant mixture is then processed to give injection-molded sheets (thickness 2 mm), with addition of concentrate I from Elastogran (2 parts by weight, component C).

### Example 27

Elastollan® 1185A from Elastogran GmbH (60 parts by weight, component A) and Magnifin® H5 MV from Albemarle Corporation (40 parts by weight, component B) are mixed using a twin-screw extruder. The resultant mixture is then processed to give injection-molded sheets (thickness 2 mm), with addition of concentrate I from Elastogran (6 parts by weight, component C).

### Example 28

The table below gives the constitution of the injection-molded sheets and selected mechanical properties. The change in mechanical properties through addition of component C relates to hardness, tensile strength, tensile strain at break, tear strength, abrasion, and the stress values at various tensile strain values. Relatively high weight-average molecular weights are obtained through addition of the crosslinking component C.

| | | Example 25 | | |
|---|---|---|---|---|
| | | (comparative | Example | Example |
| | | example) | 26 | 27 |
| Elastollan ® | parts by | 60 | 60 | 60 |
| 1185A | weight | | | |
| (component A) | | | | |
| Magnifin ® | parts by | 40 | 40 | 40 |
| H5 MV | weight | | | |
| (component B) | | | | |
| Concentrate I | parts by | 0 | 2 | 6 |
| (component C) | weight | | | |
| Shore D | [D] | 42 | 44 | 48 |
| Tensile strength | [MPa] | 15 | 23 | 22 |
| Tensile strain at | [%] | 650 | 590 | 350 |
| break | | | | |
| Tear strength | [N/mm] | 58 | 63 | 60 |
| Abrasion | [mm3] | 179 | 137 | 88 |
| 100% stress value | [MPa] | 6.8 | 7.5 | 10.3 |
| 300% stress value | [MPa] | 6.9 | 8.1 | 13.9 |
| Weight-average | [g/mol] | 57 000 | not | 173 000 |
| molar mass | | | determined | |

### Example 29

### Comparative Example

Elastollan® 1185A from Elastogran GmbH (50 parts by weight, component A) and Magnifin® H5 MV from Albemarle Corporation (50 parts by weight, component B) are mixed using a twin-screw extruder. The resultant mixture is then processed to give injection-molded sheets (thickness 2 mm).

### Example 30

Elastollan® 1185A from Elastogran GmbH (50 parts by weight, component A) and Magnifin® H5 MV from Albemarle Corporation (50 parts by weight, component B) are mixed using a twin-screw extruder. The resultant mixture is then processed to give injection-molded sheets (thickness 2 mm), with addition of concentrate I from Elastogran (2 parts by weight, component C).

### Example 31

Elastollan® 1185A from Elastogran GmbH (50 parts by weight, component A) and Magnifin® H5 MV from Albemarle Corporation (50 parts by weight, component B) are mixed using a twin-screw extruder. The resultant mixture is then processed to give injection-molded sheets (thickness 2 mm), with addition of concentrate I from Elastogran (6 parts by weight, component C).

### Example 32

The table below gives the constitution of the injection-molded sheets and selected mechanical properties. The change in mechanical properties through addition of component C relates to hardness, tensile strength, tensile strain at break, tear strength, abrasion, and the stress values at various tensile strain values. Relatively high weight-average molecular weights are obtained through addition of the crosslinking component C.

| | | Example 29 | | |
|---|---|---|---|---|
| | | (comparative | | |
| | | example) | Example 30 | Example 31 |
| Elastollan ® | parts by | 50 | 50 | 50 |
| 1185A | weight | | | |
| (component A) | | | | |
| Magnifin ® | parts by | 50 | 50 | 50 |
| H5 MV | weight | | | |
| (component B) | | | | |
| Concentrate I | parts by | 0 | 2 | 6 |
| (component C) | weight | | | |
| Shore A | [A] | 93 | 94 | 93 |
| Tensile strength | [MPa] | 9 | 16 | 16 |
| Tensile strain at | [%] | 540 | 440 | 360 |
| break | | | | |
| Tear strength | [N/mm] | 51 | 59 | 57 |
| Abrasion | [mm3] | 253 | 163 | 118 |
| 100% stress value | [MPa] | 6.4 | 8.3 | 9.8 |
| 300% stress value | [MPa] | 6.3 | 9.2 | 11.6 |
| Weight-average | [g/mol] | 50 000 | not | 145 000 |
| molar mass | | | determined | |

### Example 33

### Comparative Example

Elastollan® 1185A from Elastogran GmbH (40 parts by weight, component A) and Magnifin® H5 MV from Albemarle Corporation (60 parts by weight, component B) are mixed using a twin-screw extruder. The resultant mixture is then processed to give injection-molded sheets (thickness 2 mm).

### Example 34

Elastollan® 1185A from Elastogran GmbH (40 parts by weight, component A) and Magnifin® H5 MV from Albemarle Corporation (60 parts by weight, component B) are mixed using a twin-screw extruder. The resultant mixture is then processed to give injection-molded sheets (thickness 2 mm), with addition of concentrate I from Elastogran (2 parts by weight, component C).

### Example 35

Elastollan® 1185A from Elastogran GmbH (60 parts by weight, component A) and Magnifin® H5 MV from Albemarle Corporation (40 parts by weight, component B) are mixed using a twin-screw extruder. The resultant mixture is then processed to give injection-molded sheets (thickness 2 mm), with addition of concentrate I from Elastogran (6 parts by weight, component C).

### Example 36

The table below gives the constitution of the strips and selected mechanical properties. The change in mechanical properties through addition of component C relates to tensile strength, tensile strain at break, tear strength, and abrasion.

| | | Example 34 | | |
|---|---|---|---|---|
| | | (comparative | | |
| | | example) | Example 35 | Example 36 |
| Elastollan ® 1185A | parts by | 40 | 40 | 40 |
| (component A) | weight | | | |
| Magnifin ® H5 MV | parts by | 60 | 60 | 60 |
| (component B) | weight | | | |
| Concentrate I | parts by | 0 | 2 | 6 |
| (component C) | weight | | | |
| Shore A | [A] | 95 | 96 | 95 |
| Tensile strength | [MPa] | 6 | 9 | 10 |
| Tensile strain at | [%] | 40 | 300 | 270 |
| break | | | | |
| Tear strength | [N/mm] | 31 | 53 | 53 |
| Abrasion | [mm3] | 482 | 179 | 167 |

### Example 38

### Comparative Example

Elastollan® 1154D from Elastogran GmbH (67.5 parts by weight, component A), MELAPUR® MC15 from Ciba® (25 parts by weight, component B), and Fyrolflex® RDP (7.5 parts by weight; component B) from Supresta are mixed using a twin-screw extruder. The resultant mixture is then extruded to give strips (thickness 2 mm).

### Example 39

Elastollan® 1154A from Elastogran GmbH (67.5 parts by weight, component A), MELAPUR® MC15 from Ciba® (25 parts by weight, component B), and Fyrolflex® RDP (7.5 parts by weight; component B) from Supresta are mixed using a twin-screw extruder. The resultant mixture is then extruded to give strips (thickness 2 mm) with addition of concentrate I from Elastogran (2 parts by weight, component C).

### Example 40

The table below shows the constitution of the strips, selected mechanical properties, and also an assessment of flame retardancy to UL 94V. The change of mechanical properties through addition of component C relates to tensile strength, tensile strain at break, and the stress values at various tensile strain values.

| | | Example 38 | |
|---|---|---|---|
| | | (comparative | |
| | | example) | Example 39 |
| Elastollan ® 1154D | parts by weight | 67.5 | 67.5 |
| (component A) | | | |
| Melapur ® MC15 | parts by weight | 25 | 25 |
| (component B) | | | |
| Fyrolflex ™ RDP | parts by weight | 7.5 | 7.5 |
| (component B) | | | |
| Concentrate I | parts by weight | 0 | 2 |
| (component C) | | | |
| Tensile strength | [MPa] | 30 | 36 |
| Tensile strain at break | [%] | 400 | 330 |
| 100% stress value | [MPa] | 18 | 19 |
| 300% stress value | [MPa] | 30 | 32 |
| UL 94 V (2.0 mm) | | V-2 | V-2 |

### Example 41

### Comparative Example

Elastollan® 1185A from Elastogran GmbH (67.5 parts by weight, component A), MELAPUR® MC15 from Ciba® (25 parts by weight, component B), and Fyrolflex® RDP (7.5 parts by weight; component B) from Supresta are mixed using a twin-screw extruder. The resultant mixture is then extruded to give strips (thickness 2 mm).

### Example 42

Elastollan® 1185A from Elastogran GmbH (67.5 parts by weight, component A), MELAPUR® MC15 from Ciba® (25 parts by weight, component B), and Fyrolflex® RDP (7.5 parts by weight; component B) from Supresta are mixed using a twin-screw extruder. The resultant mixture is then extruded to give strips (thickness 2 mm) with addition of concentrate II from Elastogran (2 parts by weight, component C).

### Example 43

The table below shows the constitution of the strips, selected mechanical properties, and also an assessment of flame retardancy to UL 94V. The change in mechanical properties through addition of component C relates to tensile strength, tensile strain at break, and the stress values for various tensile strain at break values.

| | | Example 41 | |
|---|---|---|---|
| | | (comparative | |
| | | example) | Example 42 |
| Elastollan ® 1185A | parts by weight | 67.5 | 67.5 |
| (component A) | | | |
| Melapur ® MC15 | parts by weight | 25 | 25 |
| (component B) | | | |
| Fyrolflex ™ RDP | parts by weight | 7.5 | 7.5 |
| (component B) | | | |
| Concentrate II | parts by weight | 0 | 2 |
| (component C) | | | |
| Tensile strength | [MPa] | 35 | 40 |
| Tensile strain at break | [%] | 590 | 530 |
| 100% stress value | [MPa] | 7.2 | 9.1 |
| 300% stress value | [MPa] | 9.2 | 12.4 |
| UL 94 V (3 mm) | | V-0 | V-0 |

### Example 44

Elastollan® 1185A from Elastogran GmbH (40 parts by weight, component A), Magnifin® H5 MV from Albemarle Corporation (60 parts by weight, component B), and concentrate I from Elastogran (6 parts by weight, component C) are mixed using a twin-screw extruder. The mixture comprising component C has higher molecular weight (lower MFR).

| | | | |
|---|---|---|---|
| Elastollan ® 1185A | parts by weight | 40 | 40 |
| (component A) | | | |
| Magnifin ® H5 MV | parts by weight | 60 | 60 |
| (component B) | | | |
| Concentrate I | parts by weight | 0 | 4 |
| (component C) | | | |
| MFR of pellets | | 151 | 60 |
| (200° C./21.6 kg) | | | |

### Example 45

The temperature-time limits for prolonged exposure to heat were determined to DIN EN ISO 2578 (medium air, storage in ovens with natural convection) on the injection-molded sheets obtained in Example 1 (comparative example) and 2. The limiting value is in each case determined at 50% of the initial tensile strain at break value in the DIN 53504-S2 tensile test. A higher temperature index is achieved through addition of the crosslinking component C.

| | Initial | Temperature | |
|---|---|---|---|
| | tensile | index TI | Half-value |
| | strain at | for 20 000 h | interval |
| | break [%] | [° C.] | HIC [° C.] |
| Example 1 | 590 | 97.1 | 9.3 |
| (comparative | | | |
| example) | | | |
| Example 2 | 530 | 102.0 | 8.7 |

### Example 46

The temperature-time limits for prolonged exposure to heat were determined to DIN EN ISO 2578 (medium air, storage in ovens with natural convection) on the injection-molded sheets obtained in Example 21 (comparative example) and 22. The limiting value is in each case determined at 50% of the initial tensile strain at break value in the DIN 53504-S2 tensile test. A higher temperature index is achieved through addition of the crosslinking component C.

| | Initial | Temperature | |
|---|---|---|---|
| | tensile | index TI | Half-value |
| | strain at | for 20 000 h | interval |
| | break [%] | [° C.] | HIC [° C.] |
| Example 21 | 490 | 82.8 | 8.0 |
| (comparative | | | |
| example) | | | |
| Example 22 | 480 | 101.1 | 6.3 |

1. A flame-retardant mixture comprising
(A) at least one polyurethane as component A,
(B) at least one flame retardant selected from the group consisting of tallow, ammonium phosphate, ammonium polyphosphate, calcium carbonate, antimony oxide, zinc borate, clay, montmorillonite clay, a metal oxide, a metal hydroxide, an organic phosphinate compound, an organic phosphate compound, a polyhydric alcohol, a melamine compound chlorinated polyethylene, and mixtures thereof, as component B, and
(C) at least one crosslinking reagent as component C,
wherein the at least one crosslinking reagent is at least one isocyanate dissolved in at least one polyurethane.

2. The mixture according to claim 1, wherein the flame retardant has been selected from the group consisting of a melamine compound, a phosphorus compound, a metal hydroxide, and mixtures thereof.

3. The mixture according to claim 1, wherein the amount of component A present in the mixture is from 29 to 79% by weight, the amount of component B present in the mixture is from 20 to 70% by weight, and the amount of component C present in the mixture is from 1 to 20% by weight, where the total of the amounts of the components A, B and C in the mixture is 100% by weight.

4. A process for the production of a flame-retardant polyurethane comprising mixing
(A) at least one polyurethane as component A,
(B) at least one flame retardant selected from the group consisting of tallow, ammonium phosphate, ammonium polyphosphate, calcium carbonate, antimony oxide, zinc borate, clay, montmorillonite clay, a metal oxide, a metal hydroxide, an organic phosphinate compound, an organic phosphate compound, a polyhydric alcohol, a melamine compound, chlorinated polyethylene, and mixtures thereof, as component B, and
(C) at least one crosslinking reagent as component C,
wherein the at least one crosslinking reagent is at least one isocyanate dissolved in at least one polyurethane.

5. The process according to claim 4, wherein components A, B, and C are mixed simultaneously.

6. A flame-retardant polyurethane obtained by a process according to claim 4.

7-9. (canceled)

10. A molding, comprising the mixture according to claim 1.

11. A molding, comprising the flame-retardant polyurethane according to claim 6.
